(19) United States
(12) Patent Application Publication
(10) Pub. No.: US 2012/0282817 A1
(43) Pub. Date: Nov. 8, 2012

(54) PLUG CONNECTOR FOR ELECTRICAL AND ELECTRONIC CIRCUIT ELEMENTS

(75) Inventor: Rolf Finsterwalder, Peiting (DE)

(73) Assignee: ept GmbH, Peiting (DE)

(21) Appl. No.: 13/510,187

(22) PCT Filed: Nov. 19, 2010
(86) PCT No.: PCT/EP2010/007048

§ 371 Date: Jul. 24, 2012

(30) Foreign Application Priority Data
Nov. 27, 2009 (DE) 10 2009 056 171.4

(51) Int. Cl. H01R 24/58

(52) U.S. Cl. 439/668

(57) ABSTRACT

In a plug connector for electronic circuit elements, comprising an elongated housing made of insulating material and contact elements received therein, at least a portion of the contact elements are provided with a laterally arranged positioning element, which in the inserted position of the contact element cooperates with a lateral wall of the housing such that the opposite lateral walls are maintained at a target distance from each other.

### FIELD OF THE INVENTION

The invention relates to a plug connector for electrical and electronic circuit elements according to a preamble of patent claim 1.

### BACKGROUND OF THE INVENTION

Plug connectors of this type are generally known and are being used in many circuit applications, in particular for connecting circuit boards with electronic components. Plug connectors of this type typically include an elongated housing with two face walls at housing ends and two long opposing side walls. In the housing which is formed from insulating material a plurality of contact elements is received typically through insertion, wherein the contact elements are arranged behind one another in longitudinal direction of the housing. Through outfitting the housing made from plastic material there is a tendency that the contact elements in inserted position, in which they are supported through form-locking or friction-locking within the housing, press the side walls of the thin wall housing in outward direction which can cause deformations over its length, in particular bulging of the plug connector which is certainly disadvantageous.

The problem of deformation exists in particular for longer plug connectors which are configured with many contacts and which have an unfavorable ratio of wall thickness to wall length due to multiple restrictions with respect to installation space or with respect to material consumption. This has the consequence that a deformation remains also after configuring such plug connector housings with contact elements after reaching a final position since the outer walls of the plug connector do not have sufficient force for a complete reset. This problem occurs in particular for friction-locked connections.

So far the problem is being addressed in that the housings are partially configured solid or by using expensive plastic material which also has high strength besides the required insulating properties in order to provide form stability for the housing. It is another option to configure the component geometry complex in adaptation to the stability criteria which, however, requires complex tooling. Since the plug connectors are mass produced, these measures to improve the stability of the plug connector housing strongly influence their cost which is detrimental for the plug connectors in the market.

### SUMMARY OF THE INVENTION

Thus, it is an object of the invention to provide a plug connector that is configured simple and robust in which a sufficient stability is provided with simple measures also when the plug connector is configured with many contact elements and a deformation of the housing is prevented.

One aspect of the present invention, a plug connector for electrical and electronic circuit elements for connecting circuit boards includes an elongated housing made from insulating material. The elongated housing has two opposing long side walls and two opposing face walls at ends of the housing, defining a receiving cavity between one another. The receiving cavity includes a plurality of contact elements which are arranged in series behind one another in longitudinal direction of the housing. The contact elements are inserted from one side into the housing, transversal to the longitudinal axis of the housing. The contact elements are frictionally engaged therein and engage the receiving cavity of the housing. At least a portion of the contact elements is respectively provided with at least one laterally arranged positioning element. The positioning element interacts in an inserted condition of the contact element with at least one opposing long side wall of the housing so that the opposing long side walls are maintained at a predetermined target distance from one another when the contact elements are inserted.

According to the invention each contact element preferably includes laterally applied positioning elements which preferably laterally engage the upper edge of the long side walls of the insulation housing through inserting the contact element into a respective opening of the insulation housing, thus providing a fixation of the opposite side walls of the plug connector housing in the portion of the insertion opening. This facilitates in a simple manner to support the housing in its target position also for a plurality of inserted contact elements. Thus, the target position is the starting condition of the plug connector housing before insertion or arrangement of the contact elements in the housing. Through interaction of the positioning elements with the housing side walls this yields an increased stability of the plug connector itself.

Advantageously the positioning elements are thus either provided integral with the contact element typically configured as a stamped component or they are configured as components of an injection molded plastic encasement typically provided at the contact element. This means the contribution to stability according to the invention is achieved in a very cost-effective manner through measures with simple configuration. Thus, expensive materials for the insulation housing can be omitted as well as complex tools and a complex component geometry for the plug connector housing. Overall this affects the cost of the plug connector due to its simple manufacture which is significant for mass-produced plug connectors and improves their acceptance in the marketplace.

Advantageously two positioning elements are provided at a contact element, wherein the positioning elements can be provided on both sides of the contact element. Alternatively, however, it is also feasible that only one laterally arranged positioning element is provided at the contact element and that the next positioning element or at least one of the next contact elements inserted into the housing is then provided with a positioning element that is accordingly applied at the other side which in principle also facilitates the support effect and solidification of the housing after being inserted with the contact elements.

Advantageously the positioning elements are also configured as insertion elements so that they are quasi-moveable into their insertion positions through inserting the contact elements into the housing, wherein they keep the housing side walls at their desirable target distances. Thus, advantageously respective pockets configured as recesses or openings are provided at the respective face edges of the long side walls of the housing, wherein the positioning elements interact with the pockets. The positioning elements can be configured as tongues, pins, pinions or similar elements.

In an advantageous embodiment, the positioning elements or plug-in elements are supported through bars laterally at a distance from the main element of the contact elements. Eventually it is helpful in particular for the positioning elements to taper outward in a direction towards their free ends so that they are provided in particular with a slanted surface which provides a desirable contraction of the side walls through insertion of the positioning elements. Thus, it is furthermore advantageous that also the respective edge of the side wall which communicates with the cut-off side surface of the positioning element is configured with a respective slant angle. Also on the opposite side the positioning element can be provided with a bevel so that both bevels at the positioning element can be used as centering aids, thus simplifying automated insertion of the plug connectors with the contact elements.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 illustrates a sectional view of the housing of the plug connector transversal to the longitudinal axis with a contact element received therein;

FIG. 2 illustrates a detail of FIG. 1 in an enlarged view which illustrates the contact element before the insertion process; and

FIG. 3 illustrates the detail of FIG. 2 with the contact element in the position inserted into the housing.

### DETAILED DESCRIPTION OF THE EMBODIMENTS

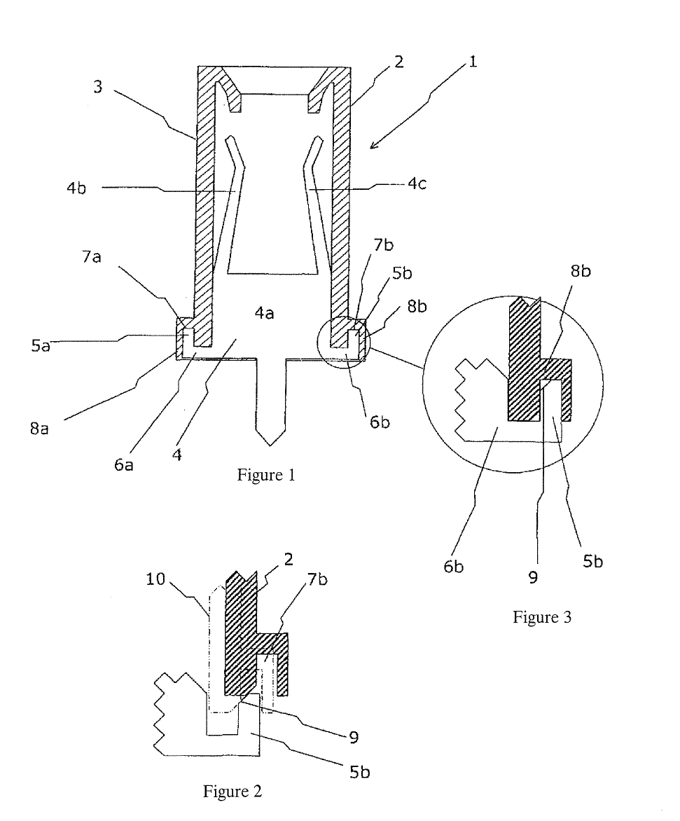

In FIG. 1, the housing of a plug connector is designated as 1, wherein the housing is typically configured elongated and includes two face walls which are not illustrated and two elongated side walls 2 and 3. The housing itself is made from insulating material, thus preferably plastic material. A plug connector of this type furthermore includes a series of contact elements 4 which are arranged behind one another at the housing in longitudinal direction of the housing and are thus arranged in the housing with their main element 4a and the contact springs 4b and 4c. The contact elements 4 are typically supported in the housing through form locking and/or friction locking, wherein they are inserted into the housing in particular from one side, here from the lower side of the housing in FIG. 1 and are supported in the housing through form locking and/or friction locking. Details do not need to be addressed herein since these are within the general skill in the plug connector art.

Typically the contact elements are made from metal, thus mostly through punching from a sheet metal blank. Typically the contact elements are partially additionally encased with injection molded plastic material which is also not illustrated in the drawing, In a practicable exemplary embodiment the housing of the plug connector of this type has a length of approx. 80 mm, wherein then approx. 80 contact elements are received behind one another in the longitudinal direction of the housing. Typically the particular contact springs are separated from the housing through ribs integrally formed at the side walls and oriented inward so that respective compartments are defined within the housing for receiving the contact elements through the ribs in order to preclude short circuits due to the adjacent contact elements contacting one another.

When inserting the contact elements into the housing respective transversal forces are generated, so that the side walls 2 and 3 can be pressed outward from their target positions which can lead to bulging and respective remaining deformations of the housing configured with the contact elements. Target position means herein the dimensions of the plastic housing before inserting the contact elements or desired contact conditions of the housing which shall be provided after inserting with the contact elements, wherein the target distance of the side walls represents the distance of the two side walls 2 and 3 before receiving the contact elements or a desirable distance to be maintained.

In order to assure the target position and for preventing respective deformations of the plug connector housing the contact elements are provided with respective positioning elements as they are formed through tongues 5a and 5b in the embodiment illustrated in FIG. 1, wherein the tongues are arranged on both sides of the contact element 4 and thus essentially on both sides of the main element 4a. The tongues 5a and 5b are thus arranged at a distance laterally from the main element 4a and connected with the main element through bars 6a and 6c. Advantageously the tongues and bars are integrally configured at the contact element, thus as an integral component of the stamped component of the contact element, wherein alternatively also the configuration of the tongues and of the bars can be part of the injection molded plastic encasement of the contact element.

On the housing side pocket shaped recesses 7a, and 7b are provided in the portion of the insertion opening of the contact element, wherein the insertion openings are used for receiving the tongues 5a and 5b and are configured complementary to them in cross section. In the illustrated embodiment thus the edge of the long side walls 2 and 3 is provided with an L-shaped shoulder 8a and 8b in which the pockets 7a and 7b are formed. The lateral distance of the tongues 5a and 5b from the center axis of the contact element thus is sized so that in inserted position of the contact element the side walls 2 and 3 are pulled to their target positions or maintained at the target position or at the desired distance through the tongues 5a and 5b engaging the pockets 7a and 7b. Through simple measures which do not increase cost by any significant amount in that the tongues are integral parts of the stamped configuration of the contact element or of the injection molded encasement of the contact element a deformation of the plastic housing due to the inserted contact elements can be very effectively prevented and the housing can be stabilized.

As an alternative to the configuration of the tongues 5a and 5b illustrated herein which are advantageously configured as portions of the stamping blank of the contact element also pinion shaped or pin shaped structures can be provided instead of tongues, thus in particular in case of the configuration of the positioning element as a portion of the plastic encasement through injection molding. The engagement pockets 7a and 7b are then configured accordingly. In the illustrated embodiment advantageously the pockets 7a and 7b extend over an entire length of each side wall 2 and 3 as continuous grooves which, however, is not mandatory. Also a punctiform and offset arrangement of the pockets or respective openings behind one another is easily feasible over the length of the side wall.

In the embodiment according to FIG. 2 the flange 5b includes a slanted surface 9 which extends from an inside to an outside of the free end of the tongue 5b. Through this slanted surface on the one hand side inserting the tongue into the respective pocket is facilitated, on the other hand side also the respective side wall, thus the side wall 2 is pulled or pushed into the target position during inserting the contact elements. Advantageously the insertion bevels are provided at both tongues 5a and 5b of the contact element, wherein FIG. 2, however, illustrates the slanted surface only at the tongue 5b for simplification purposes. FIG. 2 illustrates the target position of the side wall 2 in a dash dotted line 10 and pressing the tongue 5b in the respective pocket 7b then yields as illustrated by FIG. 3 that the side wall 2 is pulled to the left into target position and is also safely supported therein. However, it is appreciated that the target line 10 is not illustrated dimensionally correct and only the proportions shall be illustrated in order to be able to better illustrate pulling or supporting the side wall 2 and also the side wall 3 in the desired target position.

Advantageously the tongue is also provided on the outside with a slight bevel, this means in the illustrations according to FIG. 2, at the right free end of the tongue 3b so that overall two bevels can be arranged at the free end of the tongue which forms a centering aid for inserting the tongues of the contact elements into the housing which is favorable for automated insertion.

Though the contact element is illustrated in the embodiment with two tongues, respectively one tongue on the right of the contact element and one tongue on the left of the contact element, it is also feasible in an alternative embodiment to provide the contact element with a tongue only on one side, wherein the next contact element or at least one of the next contact elements which are also inserted into the housing are then provided with a respective tongue on the opposite side of the contact element. This also assures maintaining the side walls 2 and 3 at target distance, though the arrangement on both sides is advantageous in this embodiment.

1.-11. (canceled)

12. A plug connector for electrical and electronic circuit elements for connecting circuit boards, comprising:
an elongated housing made from insulating material with two opposing long side walls and two opposing face walls at ends of the housing, defining a receiving cavity between one another; and
a plurality of contact elements which are arranged in series behind one another in longitudinal direction of the housing and which are inserted from one side into the housing transversal to the housing longitudinal axis and are frictionally retained therein and which engage the receiving cavity of the housing, wherein the contact elements include a main element arranged within the housing, and wherein at least a portion of the contact elements is respectively provided with a pair of laterally arranged positioning elements respectively interact in inserted condition of the contact element with both opposing long side walls of the housing so that the opposing long side walls are maintained at a predetermined target distance from one another when the contact elements are inserted.

13. (canceled)

14. The plug connector according to claim 12, wherein the positioning elements are configured as an integral portion of the contact element.

15. The plug connector according to claim 12, wherein the positioning elements are configured as a portion of an injection molded plastic encasement of the contact element.

16. The plug connector according to claim 12, wherein the positioning elements are laterally offset from the contact element by a bar.

17. The plug connector according to claim 12, wherein the positioning elements each have an insertion element that insertably engages one of the opposing long side walls of the housing when the contact element is in the inserted condition.

18. The plug connector according to claim 17, wherein the insertion element insertably engages a recess at an edge of the long side wall of the housing.

19. The plug connector according to claim 18, wherein the recess is configured in a shoulder integrally extending from the edge of the long side wall of the housing.

20. The plug connector according to claim 13, wherein the positioning elements are configured as one of a tongue, a pin, or a pinion.

21. The plug connector according to claim 18, wherein the insertion element is tapered towards its free end from an inside towards an outside, with a slanted surface.

22. The plug connector according to claim 21, wherein the recess includes a tapered surface which is complimentary to and interacts with the slanted surface of the insertion element.

23. The plug connector according to claim 18, wherein the insertion element is provided with centering bevels at its free end that engages the recess.
